(19) United States
(12) Patent Application Publication
(10) Pub. No.: US 2023/0303374 A1
(43) Pub. Date: Sep. 28, 2023

(54) Hydraulic Control System of a Hoist Drive of a Lifting Frame of an Industrial Truck

(71) Applicant: STILL GmbH, Hamburg (DE)

(72) Inventor: Markus Schwab, Mölln (DE)

(21) Appl. No.: 18/119,868

(22) Filed: Mar. 10, 2023

(30) Foreign Application Priority Data
Mar. 22, 2022 (DE) 10 2022 106 679.7

(51) Int. Cl. B66F 9/22; F15B 20/00; F15B 13/02

(52) U.S. Cl. CPC B66F 9/22; F15B 20/008; F15B 13/024

(57) ABSTRACT

The invention relates to a hydraulic control system of a hoist drive of a lifting frame of an industrial truck, wherein the control system has a directional control valve device which is connected with a delivery line of a hydraulic pump, a reservoir line leading to a reservoir and a connecting line leading to the hoist drive, wherein the directional control valve device is configured to control the lifting operation and the lowering operation of the hoist drive. The control system has a pressure protection valve that is associated with the connecting line, wherein the pressure protection valve is configured to limit a peak pressure introduced into the lifting frame in the event of a fault scenario of the directional control valve device.

### CROSS-REFERENCE TO RELATED APPLICATION

This application claims priority to German Patent Application No. 10 2022 106 679.7 filed Mar. 22, 2022, the disclosure of which is hereby incorporated by reference in its entirety.

### BACKGROUND OF THE INVENTION

### Field of the Invention

This invention relates to a hydraulic control system of a hoist drive of a lifting frame of an industrial truck, wherein the control system has a directional control valve device which is connected with a delivery line of a hydraulic pump, a reservoir line leading to a reservoir and a connecting line leading to the hoist drive, wherein the directional control valve device is configured to control the lifting operation and the lowering operation of the hoist drive.

### Description of Related Art

In hydraulic control systems of this type, the directional control valve device is provided to control the lifting operation and the lowering operation of the hoist drive of the lifting frame of the industrial truck. The hoist drive consists of one or more hydraulic lift cylinders which raise and lower the load handling means such as a load fork, for example, which are located on the lifting frame so that they can be raised and lowered. A load on the load handling device is supported on the directional control valve device.

If, on a hydraulic control system of this type, in lowering operation during the lowering of a load, such as at the nominal load, for example, a fault scenario occurs in the directional control valve device, the directional control valve device is abruptly actuated into a neutral position or into a closed position, in which the connection between the hoist drive and the reservoir is shut off. A fault scenario of the directional control valve of this type can occur with a directional control valve device that is actuated and controlled by means of an electrical actuator device, for example in the event of a power failure of the electrical control signal of the actuator device and/or as the result of a detachment of the plug from an electrical cable that is connected with the electrical actuator device of the directional control valve device and carries the actuation signal of the actuator device. As a result of the abrupt actuation of the directional control valve device into the neutral position or the closed position in the event of a fault scenario of the directional control valve device of the type described above, the load on the load handling means is abruptly brought to a stop, and depending on the previous lowering speed of the load handling means and the weight of the load on the load handling means, a linear momentum in the form of a peak pressure is introduced into the lifting frame.

On industrial trucks of the prior art, the maximum lowering speed of the load handling means is generally <0.6 m/s. On account of changes in statutory requirements, maximum lowering speeds in current industrial trucks of more than 1 m/s, e.g. 1.2 m/s, have become possible and are being implemented.

In particular on industrial trucks that have maximum lifting speeds and or lowering speeds of the load handling means in the range of greater than 1 m/s, e.g. 1.2 m/s, in the event of a fault scenario of the type described above, for example in the event of a detachment of the plug of an electrical cable that is connected with the electrical actuator device of the directional control valve device and carries the control signal of the actuator device, as the load handling means are lowered, a strong linear momentum in the form of a peak pressure is introduced into the lifting frame. For this reason, on industrial trucks on which the maximum lifting speeds or lowering speeds of the load handling means are in the range of greater than 1 m/s, e.g. 1.2 m/s, generally as the maximum lowering and lifting speeds of the load handling means increase to the maximum lifting and/or lowering speeds of the load handling means in the range of greater than 1 m/s, e.g. 1.2 m/s, the mechanical mast structure of the lifting frame must be reinforced to prevent a failure of components of the lifting frame in the event of the fault scenario described above. However, a reinforcement of the mechanical mast structure of the lifting frame is disadvantageous because it is very expensive.

### SUMMARY OF THE INVENTION

The object of this invention is to provide a hydraulic control system and an industrial truck with a hydraulic control system which is improved with regard to the above mentioned disadvantage.

The invention accomplishes this object in that the control system has a pressure protection valve which is associated with the connecting line, whereby the pressure protection valve is designed to limit a peak pressure introduced into the lifting frame in the event of a fault scenario of the directional control valve device.

A fault scenario of the directional control valve device must in particular be considered a fault scenario of the directional control valve device in which the directional control valve device is actuated abruptly, i.e. within a few milliseconds, into a neutral position or a closed position in which the connection of the hoist drive with the reservoir line or the transport line is shut off, and therefore the lifting or lowering movement of the hoist drive and thus of the load handling means is abruptly brought to a stop. As a result of the abrupt actuation of the directional control valve device into the neutral position or the closed position in the event of a fault scenario of the directional control valve device of the type described above, the load on the load handling means is abruptly brought to a stop, and depending on the previous speed of descent of the load handling means and the weight of the load on the load handling means, a linear momentum in the form of a peak pressure is introduced into the lifting frame.

In particular, a fault scenario of the directional control valve device within the meaning of the application is a fault scenario of the directional control valve device that results in an abrupt stopping of the lifting or lowering movement of the hoist drive. This situation is also referred to herein as a fault scenario of the directional control valve device that leads to a digital stopping of the lifting movement or a digital stopping of the descending movement.

A fault scenario of the directional control valve device that results in a digital stopping of the lifting movement or a digital stopping of the lowering movement can occur in particular with a directional control valve device actuated and controlled by means of an electrical actuator device, for example in the event of a power failure of the electrical control signal of the actuator device and/or as the result of a detachment of the plug of an electrical cable which is connected with the electrical actuator device of the directional control valve device and carries the actuation signal of the actuator device.

According to the invention, for a fault scenario of this type, the pressure protection valve associated with the connecting line is provided, and in the event of such a fault scenario limits the linear momentum introduced into the lifting frame by limiting the peak pressure. As a result of the use of the pressure protection valve according to the invention, a complex and expensive reinforcement of the mechanical mast structure of the lifting frame is no longer necessary to prevent a component failure of the lifting frame in the event of the fault scenario described above.

According to one advantageous embodiment of the invention, in particular the pressure protection valve is connected with the connecting line on an input side and with the reservoir on an output side. When the pressure protection valve opens, a connection of the connecting line with the reservoir can be established to limit the peak pressure.

According to one advantageous embodiment of the invention, in particular the pressure protection valve is designed to limit the peak pressure introduced into the lifting frame in the event of the fault scenario of the directional control valve device by connecting the connecting line with the reservoir. To limit the peak pressure, therefore, the pressure protection valve in particular opens and establishes a connection between the connecting line and the reservoir.

According to one advantageous embodiment of the invention, in particular the pressure protection valve has a closed position and an open position, wherein the pressure protection valve is impinged upon toward the closed position by a spring device and toward the open position by the pressure present in the connecting line. As a result, in particular the pressure protection valve is actuated into the open position directly by the pressure present in the connecting line against the pressure of the spring device to limit the peak pressure introduced into the lifting frame.

According to one advantageous embodiment of the invention, in particular the pressure protection valve is in the form of a pressure relief valve. With a pressure relief valve, a pressure protection valve can be provided with little construction effort and expense.

According to one advantageous embodiment of the invention, in particular the pressure protection valve is in the form of a control valve, in particular a two-position control valve. The control valve is in particular in the form of a two-port, two-position valve. With a control valve of this type, a pressure protection valve can be provided with little construction effort and expense.

According to one advantageous embodiment of the invention, the control valve in particular is in the form of a switched valve or a proportional valve that has a throttling action in intermediate positions.

The spring device can particularly preferably be set to an opening pressure which is greater than the maximum system pressure of the hoist drive. The spring device can particularly preferably be set to an opening pressure which is greater than 100% or 110% or 120% of the maximum system pressure of the hoist drive.

According to one advantageous embodiment of the invention, in particular the spring device is set to an opening pressure of the pressure protection valve that is greater than 120% of the maximum system pressure of the hoist drive, preferably greater than 330 bar. With a setting of this type of the opening pressure of the pressure protection valve, the purpose of the pressure protection valve is not to protect the maximum system pressure of the hoist drive, and it therefore does not respond in normal operation during the lifting and lowering of the load handling means, but only in the event of a fault scenario of the directional control valve device, when it is actuated into the open position to limit the peak pressure introduced into the lifting frame.

According to one advantageous embodiment of the invention, in particular the control system has a pressure limiting device which is connected on the input side with the delivery line and is designed to protect the maximum system pressure of the hoist drive. With a pressure limiting device of this type connected to the delivery line, it becomes possible in a simple manner to protect and limit the maximum system pressure of the hoist drive.

According to one advantageous embodiment of the invention, in particular the directional control valve device is electrically actuated.

According to one advantageous embodiment of the invention, in particular the directional control valve device comprises a directional control valve that has a neutral position, a lowering position and a lifting position, wherein the directional control valve is actuated by a spring device into the neutral position, can be actuated by means of a first electrical actuator device, in particular a magnet, toward the lowering position, and can be actuated by means of a second electrical actuator device, in particular a magnet, toward the lifting position. With a directional control valve of this type, the lifting operation and the lowering operation of the hoist drive can be controlled with only one single directional control valve.

According to an alternative and likewise advantageous embodiment of the invention, in particular the directional control valve device comprises a lifting valve and a lowering valve, wherein the lowering valve has a closed position and a lowering position, wherein the lowering valve can be actuated by a spring device toward the closed position and by means of a first electrical actuator device, in particular a magnet, toward the lowering position, and wherein the lifting valve has a closed position and a lifting position, wherein the lifting valve is actuated by a spring device toward the closed position and by means of a second electric actuator device, in particular a magnet, toward the lifting position. With a directional control valve device of this type which has a lifting valve for controlling the lifting operation of the hoist drive and a lowering valve for controlling the lowering operation of the hoist drive, the lifting operation and the lowering operation of the hoist drive can be controlled with a simply constructed lifting valve and a simply constructed lowering valve.

The invention further relates to an industrial truck, in particular a counterbalanced fork-lift truck or a reach truck, with a lifting frame comprising a hoist drive and a hydraulic control system according to the invention.

The invention has a series of advantages.

As a result of the limitation by means of the pressure protection valve according to the invention of the peak pressures that occur in the event of a fault scenario of the directional control valve device which results in a digital stop to the lifting or a digital stop to the lowering, a reinforcement of the mechanical mast structure of the lifting frame is no longer necessary, when the maximum lifting speeds and/or lowering speeds of the load handling means are increased in a range of greater than 1 m/s, e.g. 1.2 m/s. Cost savings can thereby be achieved.

As a result of the elimination of a reinforcement of the mechanical mast structure of the lifting frame, there is also no additional interference with the vision of an operator of the industrial truck when looking through the lifting frame.

A reduction of the number of variants of the lifting frame is also possible if different variant embodiments of industrial trucks with different maximum lifting speeds and/or lowering speeds of the load handling means in the range of 0.6 m/s and in the range of 1.2 m/s are to be produced, because the variant models of an industrial tuck with maximum lifting speeds and/or lowering speeds of the load handling means in the range of 0.6 m/s and the variant models of an industrial truck with maximum lifting speeds and/or lowering speeds of the load handling means in the range of 1.2 m/s can be equipped with the same lifting frame.

### BRIEF DESCRIPTION OF THE DRAWINGS

Additional advantages and details of the invention are described in greater detail below with reference to the exemplary embodiments illustrated in the accompanying schematic figures, in which:

FIG. 1 shows a first embodiment of a hydraulic control system according to the invention of a hoist drive; and

FIG. 2 shows a second embodiment of a hydraulic control system according to the invention of a hoist drive.

### DESCRIPTION OF THE INVENTION

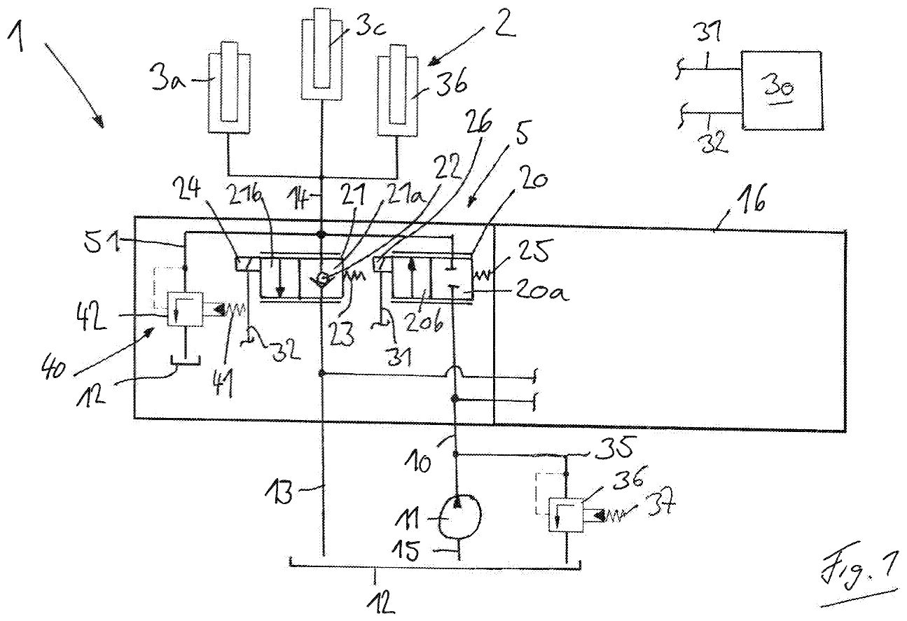

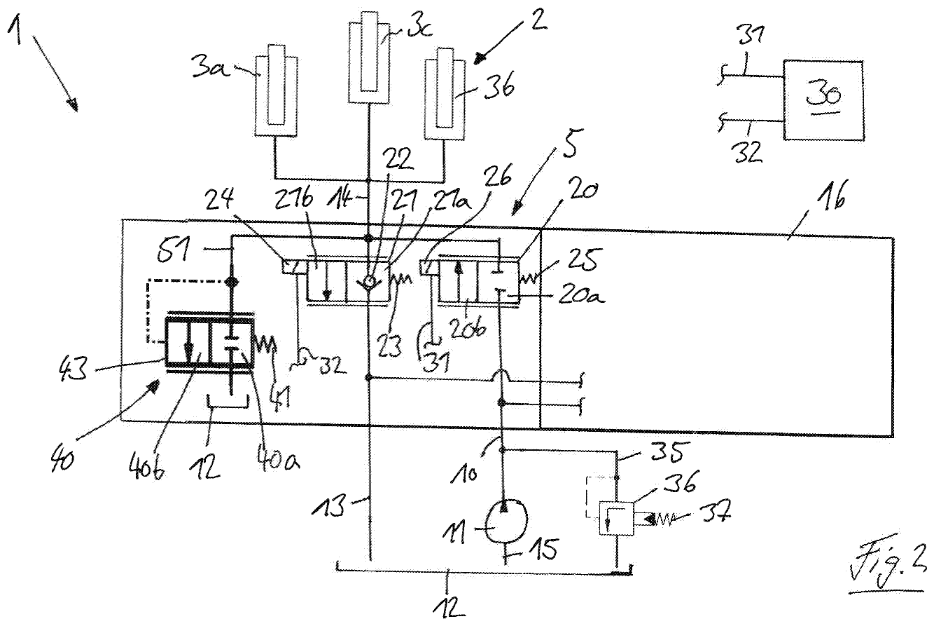

FIG. 1 and FIG. 2 each show a circuit diagram of a hydraulic control system 1 of a hoist drive 2 of a lifting frame, which is not shown in any further detail, of an industrial truck which is also not shown in any further detail.

Identical components are identified by identical reference numbers in FIGS. 1 and 2.

The control system 1 in FIGS. 1 and 2 comprises a directional control valve device 5 which is designed to control the lifting operation and the lowering operation of the hoist drive 2.

In the illustrated exemplary embodiments, the hoist drive 2 comprises a plurality of hydraulic lift cylinders 3a, 3b, 3c. The hydraulic lift cylinders 3a, 3b are in the form of mast lift cylinders, for example. The lift cylinder 3c is in the form of a free lift cylinder, for example. The lifting frame, which is not illustrated in any further detail, consists for example of a stationary mast and one or more telescoping masts that can be raised relative to the stationary mast as well as load handling means that are located so that they can be lifted in the telescoping mast that extends the highest. The lift cylinders 3a, 3b in the form of mast lift cylinders are designed to raise and lower the extension mast or the extension masts relative to the stationary mast of the lifting frame. The lift cylinder 3c in the form of a free lift cylinder is designed to raise and lower the load handling means in the telescoping mast that extends the highest.

The directional control valve 5 is connected with a delivery line 10 of a hydraulic pump 11, with a reservoir line 13 leading to a reservoir 12 and with a connecting line 14 leading to the hoist drive 2.

In the illustrated embodiments the hydraulic pump 11 is in the form of a hydraulic pump operated in an open circuit which sucks pressure medium from the reservoir line 12 by means of a suction line 15 and delivers it into the delivery line 10.

In the illustrated embodiments, the directional control valve device 5 is a component of a directional valve block 16 in which additional directional control valves can be located which are not illustrated in any further detail and are connected with the delivery line 10 and the reservoir line 13 and control additional hydraulic consumers of the industrial truck, for example a tilt drive and/or a sideshifter device of the lifting frame or of the load handling means.

In the illustrated exemplary embodiments the directional control valve device comprises a lifting valve 20 and a lowering valve 21.

The lowering valve 21 is connected with the connecting line 14 and the reservoir line 13. The lowering valve 21 has a closed position 21a and a lowering position 21b. In the lowering position 21a, the connection of the connecting line 14 with the reservoir line 13 is shut off. In the opening position 21b, the connecting line 14 is connected with the reservoir line 13. In the illustrated exemplary embodiments, the lowering valve 21 is provided with a leak-tight closed position 21a, in which a check valve 22 that shuts off the connection to the reservoir line 13 is active.

The lowering valve 21 can be actuated electrically. In the illustrated exemplary embodiments, the lowering valve is actuated toward the closed position 21a by a spring device 23 and toward the lowering position 21b by means of a first electrical actuator device 24 such as a magnet, for example.

The lifting valve 20 is connected with the connecting line 10 and the connecting line 14. The lifting valve 20 has a closed position 20a and a lifting position 20b. In the closed position 20a, the connection of the delivery line 10 with the connecting line 14 is shut off. In the opening position 20b, the delivery line 10 is connected with the connecting line 14.

The lifting valve 20 can be actuated electrically. In the illustrated exemplary embodiments, the lifting valve 20 is actuated toward the closed position 20a by a spring device 25 and toward the lifting position 20b by means of a second electrical actuator device 26 such as a magnet, for example.

For the actuation of the directional control valve device 5 a control device 30 such as an electronic control device 30 is provided, which is connected by means of electrical cables 31, 32 with the electrical actuator devices 24, 26 of the directional control valve device 5. When the directional control valve device 5 is actuated, corresponding actuation signals are carried in the electrical cables 31, 32 which impinge upon the actuator devices 24, 26.

Located in a line 35 leading from the delivery line 10 to the reservoir 12 is a pressure limiting device 36 which is connected on the input side with the delivery line 10 and is impinged upon into a closed position by a spring 37 and into an open position by the pressure present in the delivery line 10. The purpose of the pressure limiting device 36 is to protect the maximum system pressure of the hoist drive 2, for example the maximum allowable delivery pressure of the hydraulic pump 11, or to limit the nominal load of the hoist drive 2. The opening pressure of the pressure limiting device 36 determined by the spring 37 and therefore the maximum system pressure of the hoist drive 2 is set to a value of 280 bar, for example.

According to the invention, the control system 1 in FIGS. 1 and 2 has a pressure protection valve 40 which is associated with the connecting line 14. The pressure protection valve 40 is designed to limit a peak pressure introduced into the lifting frame in the event of a fault scenario of the directional control valve device 5.

In the illustrated embodiments, the pressure protection valve 40 is connected on the input side with the connecting line 14 and on the output side with the reservoir 12. For this purpose the pressure protection valve 40 is located in particular in a connecting line 51 leading from the connecting line 14 to the reservoir 12. The pressure protection valve 40 is therefore oriented and switched in parallel to the directional control valve device 5.

In the illustrated exemplary embodiments of the invention, the pressure protection valve 40 has a closed position 40a and an open position 40b, wherein the pressure protection valve 40 is impinged upon by a spring device 41 toward the closed position and by the pressure present in the connecting line 14 toward the open position.

In the exemplary embodiment illustrated in FIG. 1, the pressure protection valve 40 is a pressure relief valve 42.

In the exemplary embodiment illustrated in FIG. 2, the pressure protection valve 40 is a control valve 43, such as a two-position control valve, for example.

In the exemplary embodiment illustrated in FIG. 2, the control valve 43 is a proportional valve that exerts a throttling action in intermediate positions. Alternatively, the control valve 43 can be a switched valve.

The opening pressure of the pressure protection valve 40 specified by the spring device 41 is preferably set to a value that is greater than 120% of the maximum system pressure of the hoist drive 2. For example, if the system pressure of the hoist drive protected with the pressure limiting device 36 is 280 bar, the pressure protection valve 40 is preferably set to an opening pressure that is greater than 330 bar.

In normal operation of the control system 1 in FIGS. 1 and 2, the lifting and lowering of the hoist drive 2 is controlled by the corresponding actuation of the lifting valve 20 or the lowering valve 21. In normal operation of the control system 1, the maximum system pressure is protected by the pressure limiting device 36. The purpose of the pressure protection valve 40, the opening pressure of which is preferably at least 120% of the maximum system pressure protected by the pressure limiting device 36, is therefore not to protect the maximum system pressure in normal operation during the raising and lowering of the hoist drive 2, so that the pressure protection valve 40 does not come into use in normal operation, and in normal operation is not impinged into the open position.

The control system 1 is preferably designed so that the maximum lifting speeds and/or lowering speeds of the load handling means controlled by the hoist drive 2 are in the range of greater than 1 m/s, e.g. 1.2 m/s.

In lifting or lowering operation of the hoist drive 2, a fault scenario of the directional control valve device 5 can occur, in which the lifting valve 20 or the lowering valve 21 is abruptly actuated by the corresponding spring device 25 or 23 into the respective closed position 20a or 21a, and thus the lifting or lowering movement of the load handling means controlled by the hoist drive 2 is terminated abruptly, e.g. within a few milliseconds. In particular, a fault scenario of the directional control valve device 5 within the meaning of this application is a fault scenario of the directional control valve device 5 that results in an abrupt stopping of the lifting or lowering movement of the hoist drive 2. This situation is also referred to in the rest of this application as a fault scenario of the directional control valve device 5 that leads to a digital stopping of the lifting movement or a digital stopping of the lowering movement.

A fault scenario of this type of the directional control valve device 5 which results in a digital stopping of the lifting or lowering is in particular a loss of power to the control device 30 and/or a detachment of the plug of the electrical cable 31 or 32. As a result of the abrupt actuation of the lifting valve 20 or of the lowering valve 21 into the closed position 20a or 21a respectively in the event of a fault scenario of the type described above, the load on the load handling means is abruptly brought to a stop and, depending on the previous lifting or lowering speed of the load handling means and the weight of the load on the load handling means, a linear momentum in the form of a peak pressure is introduced into the lifting frame.

In the event of such a fault scenario that results in a sudden stopping of the lifting or lowering movement of the hoist drive 2, the pressure protection valve 40 according to the invention responds and is switched by the pressure present in the connecting line 14, against the force of the spring device 41, into the open position. In the event of such a fault scenario, which results in a sudden stop of the lifting or lowering movement of the hoist drive 2, the pressure protection valve 40 actuated into the open position limits the linear momentum introduced into the lifting frame by limiting the peak pressure. The pressure protection valve 40 according to the invention thereby makes it possible in a simple manner to prevent a component failure of the lifting frame in the event of a fault which results in a digital stopping of the lifting or lowering movement without reinforcing the mechanical mast structure of the lifting frame.

1. A hydraulic control system of a hoist drive of a lifting frame of an industrial truck, wherein the control system comprises a directional control valve device which is connected with a delivery line of a hydraulic pump, a reservoir line leading to a reservoir, and a connecting line leading to the hoist drive, wherein the directional control valve device is configured to control the lifting operation and the lowering operation of the hoist drive, wherein the control system has a pressure protection valve associated with the connecting line, and wherein the pressure protection valve is configured to limit a peak pressure introduced into the lifting frame in the event of a fault scenario of the directional control valve device.

2. The hydraulic control system according to claim 1, wherein the pressure protection valve is connected on an input side with the connecting line and on an output side with the reservoir.

3. The hydraulic control system according to claim 2, wherein the pressure protection valve limits the peak pressure introduced into the lifting frame in the event of the fault scenario of the directional control valve by connecting the connecting line with the reservoir.

4. The hydraulic control system according to claim 1, wherein the pressure protection valve has a closed position and an open position, and wherein the pressure protection valve is impinged upon by a spring device toward the closed position and by the pressure present in the connecting line toward the open position.

5. The hydraulic control system according to claim 1, wherein the pressure protection valve is a pressure relief valve.

6. The hydraulic control system according to claim 1, wherein the pressure protection valve is in the form of a control valve.

7. The hydraulic control system according to claim 6, wherein the control valve is in the form of a switched valve or a proportional valve that acts as a throttle in intermediate positions.

8. The hydraulic control system according to claim 4, wherein the spring device is set to an opening pressure of the pressure protection valve that is greater than 120% of the maximum system pressure of the hoist drive.

9. The hydraulic control system according to claim 8, wherein the control system has a pressure limiting device which is connected on an input side with the delivery line to protect the maximum system pressure of the hoist drive.

10. The hydraulic control system according to claim 1, wherein the directional control valve device is electrically actuated.

11. The hydraulic control system according to claim 10, wherein the directional control valve device comprises a directional control valve that has a neutral position, a lowering position and a lifting position, wherein the directional control valve is actuated by a spring device into the neutral position, actuated by a first electrical actuator device toward the lowering position, and actuated by a second electrical actuator device toward the lifting position.

12. The hydraulic control system according to claim 10, wherein the directional control valve device comprises a lifting valve and a lowering valve, wherein the lowering valve has a closed position and a lowering position, wherein the lowering valve is actuated toward the closed position by a spring device and actuated by a first electrical actuator device toward the lowering position, wherein the lift valve has a closed position and a lift position, and wherein the lift valve is actuated by a spring device toward the closed position and by a second electric actuator device toward the lift position.

13. An industrial truck comprising a counterweighted forklift truck or a reach truck, with a lifting frame comprising a hoist drive and a hydraulic control system according to claim 1 for controlling the hoist drive.

14. The hydraulic control system according to claim 6, wherein the control valve is a two position control valve.

15. The hydraulic control system according to claim 8, wherein the spring device is set to an opening pressure of the pressure protection valve that is greater 330 bar.

16. The hydraulic control system according to claim 11, wherein the first electrical actuator device is a magnet and the second electrical actuator device is a magnet.

17. The hydraulic control system according to claim 12, wherein the first electrical actuator device is a magnet and the second electric actuator device is magnet.
